(19) United States
(12) Patent Application Publication
(10) Pub. No.: US 2024/0111202 A1
(43) Pub. Date: Apr. 4, 2024

(54) APERTURE DRIVING MODULES, CAMERA MODULES INCLUDING THE SAME AND METHODS OF OPERATING THE APERTURE DRIVING MODULE

(71) Applicant: Samsung Electronics Co., Ltd., Suwon-si (KR)

(72) Inventor: Minook Kim, Suwon-si (KR)

(21) Appl. No.: 18/462,636

(22) Filed: Sep. 7, 2023

(30) Foreign Application Priority Data
Sep. 23, 2022 (KR) 10-2022-0121151

(51) Int. Cl. G03B 9/06; G03B 30/00

(52) U.S. Cl. CPC G03B 9/06; G03B 30/00

(57) ABSTRACT

An aperture driving module includes a barrel that contains a first fixed electret therein, and is configured to support an optical lens. An aperture blade is provided, which is configured to adjust an amount of light received by the optical lens, upon movement of the aperture blade. A driving unit is provided with a first driving electret. The driving unit is configured to move the aperture blade in response to application of a current to a voice coil motor (VCM), which has a magnet therein and is mounted adjacent a portion of the driving unit. The first fixed electret extends apart from the magnet in a Y-axis direction, and the first driving electret extends apart from the magnet in an X-axis direction.

### REFERENCE TO PRIORITY APPLICATION

This application claims priority under 35 U.S.C. § 119 to Korean Patent Application No. 10-2022-0121151, filed Sep. 23, 2022, the disclosure of which is hereby incorporated herein by reference.

### BACKGROUND

The inventive concept relates to an aperture driving module, a camera module including the same, and an operating method of the aperture driving module. More particularly, the inventive concept relates to an aperture driving module including an electret, a camera module including the same, and an operating method of the aperture driving module including an electret.

With the development of information technology (IT), various types of electronic devices, such as smartphones and tablet personal computers (PCs) have become widely prevalent. Some of these electronic devices may include a camera module. The camera module may be miniaturized to be included in electronic devices and may include various functions. For example, the camera module may include a zoom function to enlarge or reduce an object to be imaged at various magnifications. As another example, the camera module may include an auto focusing (AF) function.

In order to support the various functions, the camera module typically requires a plurality of actuators capable of changing positions of a plurality of lenses included therein and an aperture driving module capable of adjusting the amount of light applied to the lenses. The aperture driving module may be driven by applying a current to a voice coil motor (VCM) using a magnetic field generated in response to a current flowing through the coil.

### SUMMARY

The inventive concept provides an aperture driving module that does not consume additional power to maintain a fixed position of an aperture.

According to an aspect of the inventive concept, there is provided an aperture driving module. The aperture driving module may include a barrel supporting a lens, an aperture blade capable of adjusting an amount of light applied to the lens, and a driving unit physically connected to the aperture blade, and attached to a side surface of the barrel. The driving unit may drive the aperture blade using a current applied to a voice coil motor (VCM). A magnet included in the VCM may be mounted at a center of the driving unit. The barrel may include a first fixed electret. The driving unit may include a first driving electret. In some embodiments, the first fixed electret may be located in a position apart from the magnet in a Y-axis direction, and the first driving electret may be located in a position apart from the magnet in an X-axis direction.

According to another aspect of the inventive concept, there is provided a camera module. The camera module includes an aperture driving module driven by a current flowing through a voice coil motor (VCM) and a lens controller controlling a current flowing through the VCM. The aperture driving module includes a barrel supporting the lens, an aperture blade capable of adjusting an amount of light applied to the lens, and a driving unit physically connected to the aperture blade and attached to the barrel to drive the aperture blade. The driving unit has a first size of an opening in a first fixed position and a second size of the opening in a second fixed position, and the lens controller controls turning off the current flowing through the VCM when the driving unit is in the first fixed position and the second fixed position.

According to another aspect of the inventive concept, there is provided an aperture driving module. The aperture driving module includes a barrel including a fixed electret and supporting a lens and a driving unit including a plurality of driving electrets and attached to the barrel to move aperture blades. The driving unit is fixed in a plurality of fixed positions that are equal to or greater than the number of driving electrets. And, in each of the plurality of fixed positions, Coulomb forces between at least one of the plurality of driving electrets and the fixed electret has a value greater than a weight of the driving unit.

According to another aspect of the inventive concept, there is provided an operating method of an aperture driving module. The operating method of an aperture driving module, which adjusts a size of an aperture through an aperture blade and is driven by a voice coil motor (VCM), includes applying a current to a coil of the VCM, moving a driving unit connected to the aperture blade by the current, and turning off the current when a fixed position of the aperture by the aperture blade is determined.

### BRIEF DESCRIPTION OF THE DRAWINGS

Embodiments of the inventive concept will be more clearly understood from the following detailed description taken in conjunction with the accompanying drawings in which:

FIG. 1 is a block diagram illustrating a configuration of an electronic device according to an embodiment;

FIG. 2 is a block diagram illustrating a configuration of a camera module according to an embodiment;

FIG. 3A is a perspective view illustrating an aperture driving module according to an embodiment;

FIG. 3B is a top view and an enlarged view of an aperture driving module according to an embodiment;

FIG. 3C is a view illustrating an operation when a size of an opening is maximum and when the size of the opening is minimum according to an embodiment;

FIG. 4A is a partial plan view of an aperture driving module according to an embodiment;

FIGS. 4B to 4D are views illustrating the operating principle of the aperture driving module of FIG. 4A;

FIG. 5 is a partial plan view of an aperture driving module according to an embodiment;

FIG. 6 is a partial plan view of an aperture driving module according to an embodiment;

FIG. 7 is a flowchart illustrating an operating method of an aperture driving module according to an embodiment; and

FIG. 8 is a flowchart illustrating an operating method of an aperture driving module according to an embodiment.

### DETAILED DESCRIPTION OF THE EMBODIMENTS

Hereinafter, embodiments are described in detail with reference to the accompanying drawings. In addition, an aperture driving module according to an embodiment is described in detail with reference to the accompanying drawings. Like reference numerals or marks in each drawing denote parts or components that perform substantially the same function.

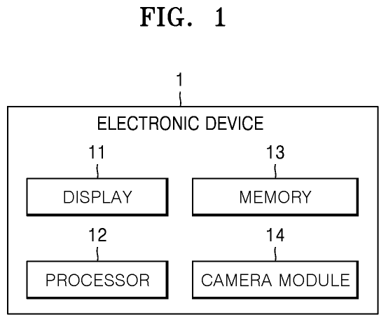

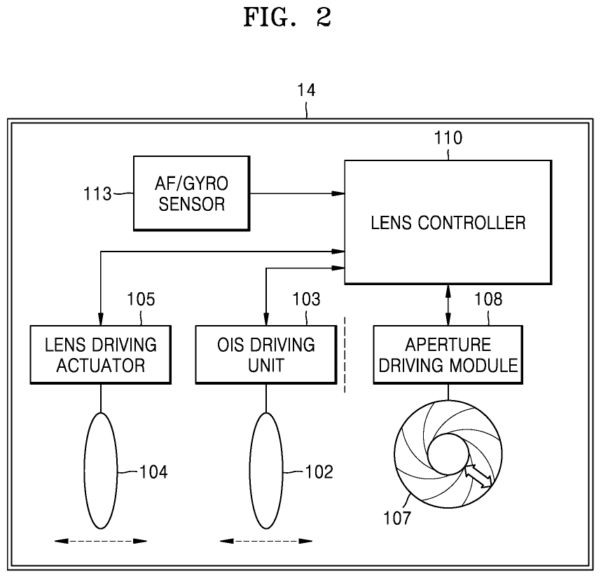

FIG. 1 is a block diagram illustrating a configuration of an electronic device 1 according to an embodiment, and FIG. 2 is a block diagram illustrating a configuration of a camera module 14 according to an embodiment, which is illustrated as a component of the electronic device 1 of FIG. 1. Referring to FIG. 1, the electronic device 1 according to an embodiment may include a display 11, a processor 12, a memory 13, and a camera module 14. All cameras of the camera module 14 may be cameras included in the electronic device 1.

The display 11, the processor 12, the memory 13, and the camera module 14 may be electrically connected to each other to exchange signals (e.g., commands or data) with each other. The electronic device 1 may be various types of devices. For example, the electronic device 1 may include a portable communication device (e.g., a smartphone), a portable multimedia device, a portable medical device, and a wearable device. An electronic device according to an embodiment is not limited to the aforementioned devices.

The processor 12 may include at least one processor. For example, the processor 12 may include at least one of an application processor (AP), an image signal processor (ISP), and a communication processor (CP). The processor 12 may control the camera module 14. The processor 12 may support various functions using the camera module 14. The processor 12 may obtain imaged content from the camera module 14 by controlling the camera module 14. The processor 12 may store the imaged content obtained through the camera module 14 in the memory 13 or process the obtained imaged content in real time. The processor 12 may control the display 11. The processor 12 may display the imaged content through the display 11. For example, the imaged content may be displayed on a screen of an executed application, while an application (e.g., a camera application or an image capture application) is being executed. According to an example, the processor 12 may control an optical image stabilizer (OIS) driving unit 103, a lens driving actuator 105, a lens controller 110, and an aperture driving module 108, which are elements of the camera module 14 shown by FIG. 2. In particular, the processor 12 may execute an application and control various types of hardware by executing code written in a programming language stored in the memory 13 of the electronic device 1. For example, the processor 12 may execute an application (e.g., the camera application or the image capture application) and display imaged content or a user interface (UI) related to the imaged content on a screen of an executed application. As instructions stored in the memory 13 are executed, the operation of the processor 12 may be performed.

Referring to FIG. 2, the camera module 14 according to an embodiment may include a zoom lens 102, the OIS driving unit 103, a focus lens 104 changing a focal position, the lens driving actuator 105, an aperture 107, the aperture driving module 108, the lens controller 110, and an AF/gyro sensor 113. In addition, the zoom lens 102 and the focus lens 104 may be configured as a lens group in which a plurality of lenses are combined. The AF/gyro sensor 113 may collect information related to autofocusing and hand shake operations.

The OIS driving unit 103, the lens driving actuator 105, and the aperture driving module 108 are controlled by the lens controller 110 to drive the zoom lens 102, the focus lens 104, and the aperture 107, respectively. For example, the OIS driving unit 103 may drive the zoom lens 102 based on the information collected by the AF/gyro sensor 113. The lens driving actuator 105 may adjust a focus to move the focus lens 104 in an optical axis direction. According to an example, the lens driving actuator 105 and the OIS driving unit 103 may be integrated with one another.

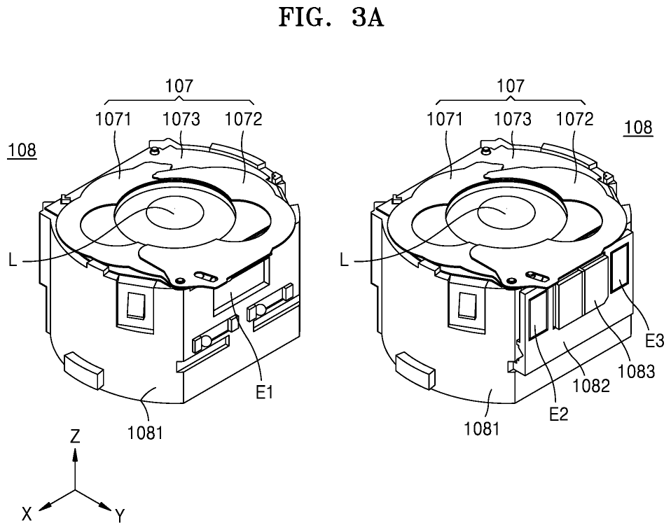

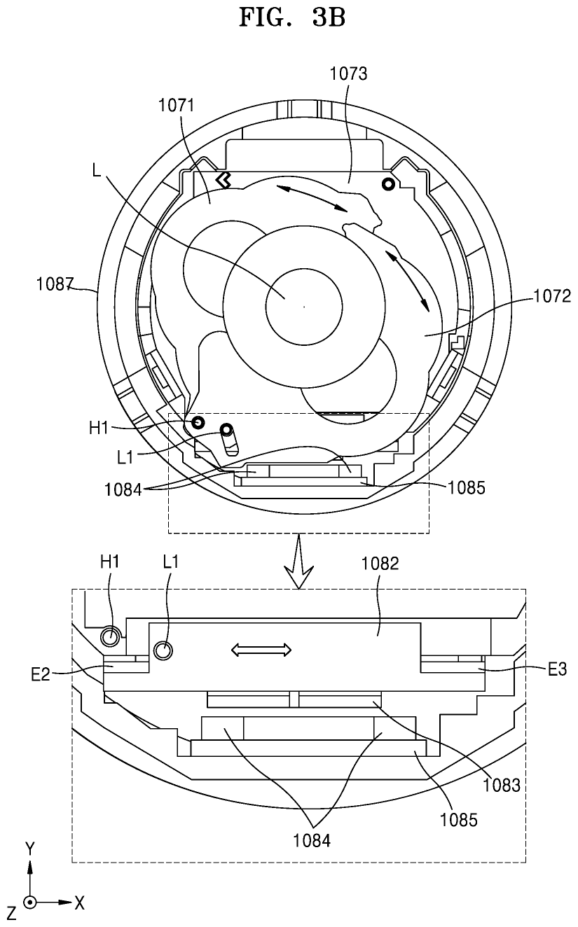

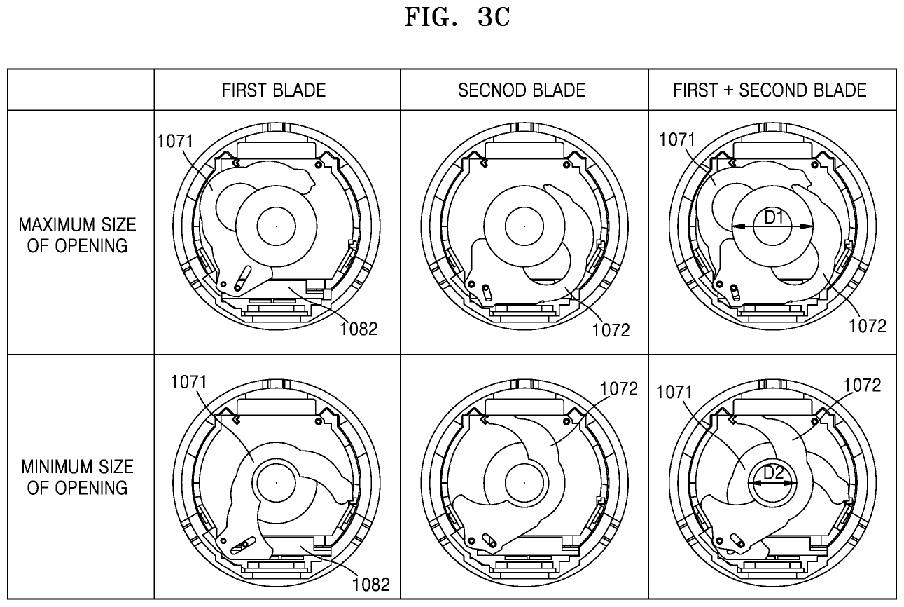

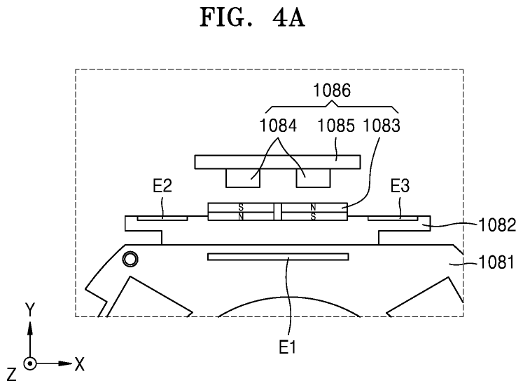

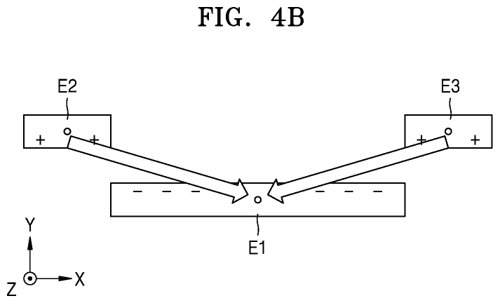

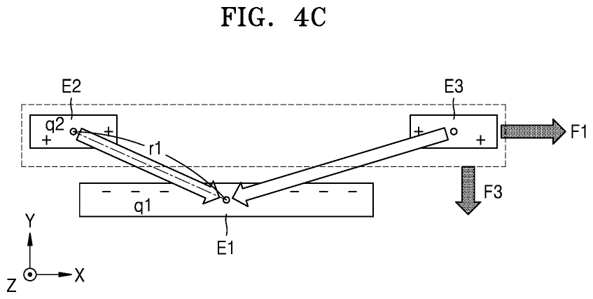

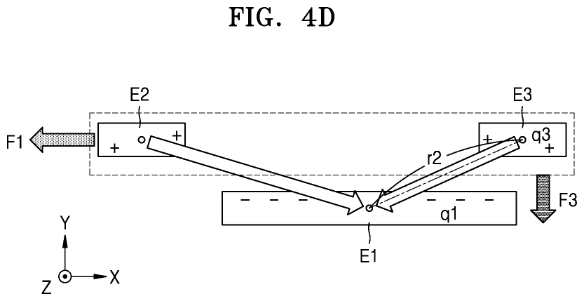

The aperture driving module 108 according to the inventive concept may adjust the amount of light applied to the zoom lens 102 or the focus lens 104 by adjusting aperture blades 1071 and 1072 (or a first blade 1071 and a second blade 1072) of the aperture 107 (refer to FIG. 3A). The aperture driving module 108 may be driven by a voice coil motor (VCM). A VCM 1086 may include a coil 1084 and a magnet 1083, as shown by FIG. 4A. The VCM 1086 may drive the aperture driving module 108 using a magnetic field generated by a current flowing through the coil 1084. According to an example, the current applied to the coil 1084 of the VCM 1086 may be controlled by the lens controller 110. According to another example, the aperture driving module 108 may include electrets, which may be [symbol] The aperture driving module 108 may fix the aperture blades 1071 and 1072 in specific positions by utilizing attraction between the electrets. A detailed description of the aperture driving module 108 according to the inventive concept is given below.

FIG. 3A is a perspective view of the aperture driving module 108 of the camera module 14 according to an embodiment. The left view of FIG. 3A is a perspective view illustrating a structure in which a fixed electret E1 is included in a barrel 1081 of the aperture driving module 108, and the right view of FIG. 3A is a perspective view illustrating a structure in which a driving unit 1082 of the aperture driving module 108 is located on the barrel 1081. According to an example, it should be noted that the left view of FIG. 3A is a perspective view that does not show the driving unit 1082.

Referring to the left view of FIG. 3A, the aperture driving module 108 including the barrel 1081 may have a generally cylindrical shape, as shown. The barrel 1081 may be a lens barrel that supports a lens L therein. According to an example, the barrel 1081 having a cylindrical shape is provided to support the lens L and the aperture 107. The lens L may be the zoom lens 102 (refer to FIG. 2) or the focus lens 104 (refer to FIG. 2). However, the barrel 1081 is not limited to a lens barrel, and may be a cam barrel connecting the lens barrel supporting the lens L to the aperture driving module 108.

Referring to the left view of FIG. 3A, the barrel 1081 may include the fixed electret E1, which may extend adjacent one side of the barrel 1081 in the Y-axis direction. The fixed electret E1 may be built in the barrel 1081. According to another example, the fixed electret E1 may be located in a recess of a side surface of the barrel 1081. Referring to the right view of FIG. 3A, the driving unit 1082 may be located in an upper portion of the barrel 1081 in the Y-axis direction. According to an example, the driving unit 1082 may be a magnet holder. The magnet 1083 held by the driving unit 1082 may be a magnet included in the VCM 1086 (refer to FIG. 4A). It should be noted that FIG. 3A does not illustrate the coil 1084 (refer to FIG. 4A) included in the VCM 1086 (refer to FIG. 4) for convenience of description. According to an example, the VCM 1086 (refer to FIG. 4A) may include the magnet 1083, the coil 1084 (refer to FIG. 4A), and a substrate 1085 (refer to FIG. 4A) to which the coil 1084 is attached.

Referring still to the right view of FIG. 3A, the driving unit 1082 may include driving electrets E2 and E3. The driving unit 1082 may include a plurality of driving electrets E2 and E3. In the inventive concept, the electrets included in the driving unit 1082 are referred to as driving electrets E2 and E3, and the electret included in the barrel 1081 is referred to as the fixed electret E1.

Referring to FIG. 3A, a lens L may be located above the barrel 1081 in the Z-axis direction, and the aperture 107 may be located above the lens L. The aperture 107 may include the aperture blades 1071 and 1072 and an aperture base 1073. The aperture base 1073 may be located below the aperture blades 1071 and 1072. The aperture blades 1071 and 1072 may be connected to an end portion of the driving unit 1082. Positions of the aperture blades 1071 and 1072 may be changed by movement of the driving unit 1082. An opening of the aperture 107 may be adjusted by a combination of the aperture blades 1071 and 1072. The opening of the aperture 107 may be adjusted so that a size of the opening of the aperture 107 may increase or decrease. In the inventive concept, the term “size of the opening” may refer to a size of a region which the aperture blades 1071 and 1072 included in the aperture 107 are combined with each other to allow light transmitted through the lens L to pass therethrough.

A driving method of the aperture driving module 108 shown in FIG. 3A is described with reference to FIGS. 3B and 3C. FIG. 3B is a top view illustrating an operation of the aperture driving module 108 according to an embodiment. The upper view of FIG. 3B is a view of the aperture driving module 108 of FIG. 3A in the Z-axis direction, and the lower view of FIG. 3B is an enlarged view of the dashed line portion of the upper view of FIG. 3B. It should be understood that, in the enlarged view of FIG. 3B, the aperture blades 1071 and 1072 are omitted for convenience of description.

Referring to FIG. 3B, the aperture blades 1071 and 1072 connected to the driving unit 1082 are shown. Referring to FIG. 3B, the number of aperture blades 1071 and 1072 may be two in some embodiments, however, additional blades may be provided in alternative embodiments. One end portion of each of the aperture blades 1071 and 1072 may be connected to one end portion of the driving unit 1082 through a lever L1 and a hinge H1. Referring to FIG. 3B, as the driving unit 1082 moves in the X-axis direction, the aperture blades 1071 and 1072 may separately move, according to which the size of the opening may be determined. According to an example, an external member 1087 surrounding the barrel 1081 and the lens L may be provided. According to an example, the external member 1087 may have a cylindrical shape surrounding the barrel 1081. According to an example, a range in which the driving unit 1082 may move may be determined according to an internal shape of the external member 1087. Referring to the enlarged view of FIG. 3B, it can be seen that the driving unit 1082 has moved to the maximum in the direction toward the first driving electret E2.

FIG. 3C is a view illustrating adjusting the size of the opening according to an embodiment. Upper drawings of FIG. 3C show an embodiment in which the size of the opening is maximized, and lower drawings of FIG. 3C show an embodiment in which the size of the opening is minimized. Referring to the upper drawings of FIG. 3C, the respective shapes of the first blade 1071 and the second blade 1072 included in the aperture 107 are shown, and an embodiment in which the first blade 1071 and the second blade 1072 are combined to maximize the size of the opening is shown. Referring to FIG. 3C, when the driving unit 1082 is located at the left end portion, a diameter of the opening of the aperture by the first blade 1071 and the second blade 1072 may be a first diameter D1, which is a maximum value. The first diameter D1 may be a first size of the opening.

Referring to the lower drawings of FIG. 3C, the respective shapes of the first blade 1071 and the second blade 1072 included in the aperture 107 are shown, and an embodiment in which the first blade 1071 and the second blade 1072 are combined to minimize the size of the opening is shown. Referring to FIG. 3C, when the driving unit 1082 is located at the right end portion, a diameter of the opening of the aperture by the first blade 1071 and the second blade 1072 may be a second diameter D2, which is a minimum value. The second diameter D2 may be a second size of the opening. According to an example, the first diameter D1 may be greater than the second diameter D2.

Referring to the upper drawings of FIG. 3C, the aperture in a state in which the driving unit 1082 has moved more toward the left end portion is shown. Referring to the lower drawings of FIG. 3C, the aperture in a state in which the driving unit 1082 has moved more toward the right end portion is shown. That is, referring to FIG. 3C, it can be seen that the size of the opening may be adjusted according to a moving position of the driving unit 1082.

In the inventive concept, it can be seen that the positions of the driving unit 1082 are different when the size of the opening in FIG. 3C is maximum and the size of the opening is minimum. According to an example, when the size of the opening is maximum and the size of the opening is minimum, the driving unit 1082 should be fixed in the corresponding positions. According to an example, the position of the driving unit 1082 when the opening has the first diameter D1, which is the maximum, may be the second fixed position. According to an example, the position of the driving unit 1082 when the opening has the second diameter D2, which is the minimum, may be the first fixed position. A method and structure for fixing the driving unit 1082 in the first fixed position and the second fixed position are described in detail with reference to the following drawings.

FIG. 4A is a partial plan view of the aperture driving module 108 according to an embodiment. Referring to FIG. 4A, the aperture driving module 108 may include the barrel 1081, the driving unit 1082 located above the barrel 1081 in the Y-axis direction, and the VCM 1086 capable of driving the driving unit 1082. The barrel 1081 may include the fixed electret E1. The fixed electret E1 may be embedded in the barrel 1081. According to an example, the fixed electret E1 may be located in the center of the barrel 1081. According to an example, the fixed electret E1 may be located in a position apart from the magnet 1083 included in the VCM 1086 in the Y-axis direction.

According to an example, the driving unit 1082 may be a magnet holder. A moving direction of the driving unit 1082 may change according to a direction of a current applied to the coil 1084 of the VCM 1086. According to an example, the VCM 1086 may include the magnet 1083, the coil 1084, and the substrate 1085. When a current is applied to the coil 1084, the driving unit 1082 holding the magnet 1083 may move in the X-axis direction by the Lorentz force.

According to an example, the driving unit 1082 may include the driving electrets E2 and E3. The driving unit 1082 may include the driving electret E2 as a first driving electret and the driving electret E3 as a second driving electret. The first driving electret E2 and the second driving electret E3 may be located at positions apart from the magnet 1083 included in the VCM 1086 in the X-axis direction.

The first driving electrets, the second driving electrets E2 and E3 and the fixed electrets E1 may be electrets. As will be understood by those skilled in the art, an electret is a dielectric can be semi-permanently charged. Advantageously, an electret can be a material in which a negative or positive charge remains even when an external magnetic field is removed. According to an example, a material of the first and second driving electrets E2 and E3 and the fixed electret E1 may be any one of teflon, PTFE, and Cyclized Transparent Optical Polymer (CYTOP). According to an example, a material having heat resistance and chemical resistance may be used as a material of the first and second driving electrets E2 and E3 and the fixed electrets E1. According to an example, a material having a high charge storage capacity may be used as a material of the first and second driving electrets E2 and E3 and the fixed electret E1. According to an example, a commercial plastic material may be used as an electret, so that material costs may be reduced and the camera module may be miniaturized.

Referring back to FIG. 4A, the first driving electrets E2 and the second driving electret E3 included in the driving unit 1082 may be located in symmetrical positions with respect to a center point of the driving unit 1082. The first driving electret E2 and the second driving electret E3 may be electrets charged with the same charges. According to an example, the fixed electret E1 included in the barrel 1081 may be charged with charges opposite to those of the first and second driving electrets E2 and E3 included in the driving unit 1082.

According to an example, charge densities of the fixed electret E1 included in the barrel 1081 and the first driving electret E2 and the second driving electret E3 included in the driving unit 1082 may be about 0.1 to about 10 mC/m² (milli Coulomb per meter squared). According to an example, thicknesses of the fixed electret E1 included in the barrel 1081 and the first driving electret E2 and the second driving electret E3 included in the driving unit 1082 may be in a range of about 0.01 to about 1 mm. According to an example, distances between the fixed electret E1 included in the barrel 1081 and the first driving electret E2 and the second driving electret E3 included in the driving unit 1082 may be in a range of about 0.02 mm to about 5 mm.

FIGS. 4B to 4D are views illustrating an operating method of the aperture driving module 108 according to an embodiment. In FIGS. 4B to 4D, for convenience of description, in the aperture driving module 108 shown in FIG. 4A, only the fixed electret E1 included in the barrel 1081 and the first driving electret E2 and the second driving electret E3 included in the driving unit 1082 are shown. According to an example, in FIGS. 4B to 4D, the fixed electret E1 may not move and only the first driving electret E2 and the second driving electret E3 may move in the X-axis direction.

FIG. 4B is a view illustrating a state in which the aperture driving module 108 is in a neutral position. According to an example, FIG. 4B may refer to a state before a current is applied to a voice coil motor (VCM). In a state before a current is applied to the VCM, the driving unit 1082 may be located in a neutral position before driving the aperture. When the driving unit 1082 is located in the neutral position, the first driving electret E2 and the second driving electret E3 included in the driving unit 1082 and the fixed electret E1 included in the barrel 1081 may be electrically balanced.

FIG. 4C is a view illustrating a state in which the aperture driving module 108 is in a first fixed position. FIG. 4D is a view illustrating a state in which the aperture driving module 108 is in a second fixed position. According to an example, the state in which the aperture driving module 108 of FIG. 4C is in the first fixed position may mean a state in which the aperture driving module 108 has moved to a first end portion in the X-axis direction, and the state in which the aperture driving module 108 of FIG. 4D is in the second fixed position may mean a state in which the aperture driving module 108 has moved to a second end portion in the X-axis direction. The first and second end portions may refer to both end portions to which the driving unit 1082 of the aperture driving module 108 may move maximally.

Referring to FIG. 4C, the first driving electret E2 and the second driving electret E3 included in the driving unit 1082 may be charged with the same charge, and the fixed electret E1 included in the barrel 1081 may be charged with charges opposite to that of the first driving electret E2 and the second driving electret E3. Referring to FIG. 4C, the first driving electret E2 and the second driving electret E3 may be charged with positive charges, and the fixed electret E1 may be charged with negative charges. However, this is only an example, and the first driving electret E2 and the second driving electret E3 may be charged with negative charges, and the fixed electret E1 may be charged with positive charges. According to another example, the first driving electret E2, the second driving electret E3, and the fixed electret E1 may all be charged with the same type of charges. According to an example, the first driving electret E2, the second driving electret E3, and the fixed electret E1 may be charged with positive charges.

Referring to FIG. 4C, in the first fixed position, the first driving electret E2 included in the driving unit 1082 may be closer to the fixed electret E1 included in the barrel 1081. The second driving electret E3 included in the driving unit 1082 may be distant from the fixed electret E1 included in the barrel 1081. As the first driving electret E2 included in the driving unit 1082 is close to the fixed electret E1 included in the barrel 1081, the first driving electret E2 may be fixed in the first fixed position through Coulomb force between the first driving electret E2 and the fixed electret E1. According to an example, the Coulomb force between the first driving electret E2 and the fixed electret E1 may be greater than a weight F3 of the driving unit 1082 and may be less than a moving force F1 by the VCM. The reason why the Coulomb force between the first driving electret E2 and the fixed electret E1 is greater than the weight F3 of the driving unit 1082 is because the first driving electret E2 may be fixed in the first fixed position when Coulomb force enough to withstand the weight of the driving unit 1082 is applied. According to an example, the fixed position may be determined in a position in which a condition that the Coulomb force perpendicular to a moving direction of the driving unit 1082 is greater than the weight of the driving unit 1082 is satisfied. The reason why the Coulomb force between the first driving electret E2 and the fixed electret E1 is less than the moving force F1 by the VCM is because the Coulomb force is a force provided for fixation so that the Coulomb force needs to be less than the moving force F1 by the VCM applied to determine a position of the aperture. The aperture may be fixed in a position in which the condition of force (F1) by the VCM is greater than a Coulomb force between the fixed electret and driving electret, which is greater than the weight F3 of the driving unit, when expressed by a formula, is satisfied.

Based on the above condition, a condition of the Coulomb force between the first driving electret E2 and the fixed electret E1 may be expressed as follows.

$$F 1 > {k}_{e} \frac{q 1 q 2}{{r}_{1}^{2}} > F 3$$

In the above formula, kₑ may be a Coulomb constant, r₁ may be a distance between a center point of the first driving electret E2 and a center point of the fixed electret E1, and q1q2 may be the product of the magnitude of charges included in the fixed electret E1 and the magnitude of charges included in the first driving electret E2.

FIG. 4D is opposite to FIG. 4C only in direction, but the principle may be the same. Referring to FIG. 4D, at the second fixed position, the second driving electret E3 included in the driving unit 1082 may be close to the fixed electret E1 included in the barrel 1081. As the second driving electret E3 included in the driving unit 1082 is close to the fixed electret E1 included in the barrel 1081, the Coulomb force may be generated between the first driving electret E2 and the fixed electret E1, through which the second driving electret E3 may be fixed in the second fixed position.

In FIG. 4D, a condition of the Coulomb force between the second driving electret E3 and the fixed electret E1 may be expressed as follows.

$$F 1 > {k}_{e} \frac{q 1 q 3}{{r}_{2}^{2}} > F 3$$

In the above formula, kₑ may be a Coulomb constant, r₂ may be a distance between a center point of the second driving electret E3 and a center point of the fixed electret E1, and q1q3 may be the product of the magnitude of charges included in the fixed electret E1 and the magnitude of charges included in the second driving electret E3.

Referring to FIGS. 4B to 4D, after the driving unit 1082 moves to each fixed position, the aperture may be fixed through attraction between the fixed electret E1 included in the barrel 1081 and the driving electrets E2 and E3 included in the driving unit 1082 in the corresponding fixed position. In particular, FIGS. 4B to 4D illustrate the principle of operation of the aperture driving module 108 having the structure shown in FIG. 4, but this may also be applied to an aperture driving module having other structures. With reference to FIGS. 4B to 4D, it is described that the apertures may be fixed in each fixed position through the Coulomb force between one driving electret E2 or E3 included in the driving unit 1082 and one fixed electret E1 included in the barrel 1081, but the aperture may also be fixed by Coulomb force between three or more electrets.

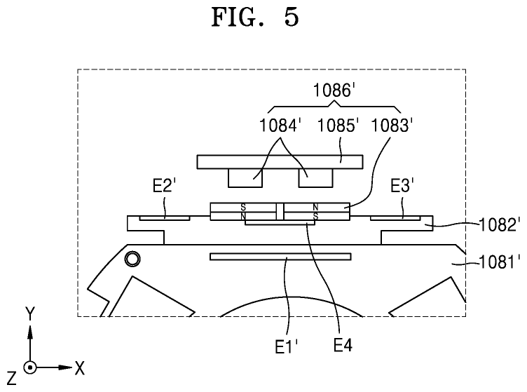

FIG. 5 is a partial plan view of an aperture driving module 108 according to an embodiment. In the example of FIG. 5, redundant descriptions of portions described above with reference to FIG. 4A may be omitted. Referring to FIG. 5, a driving unit 1082′ may further include a driving electret. According to an example, the driving unit 1082′ of FIG. 5 may include a first driving electret E2′, a second driving electret E3′, and a third driving electret E4. Compared to FIG. 4A, the driving unit 1082′ may additionally include the third driving electret E4 in the center of the driving unit 1082′. The third driving electret E4 may have the same size and thickness as those of the first driving electrets E2′ and the second driving electrets E3′. According to another example, the first driving electrets E2′, the second driving electrets E3′, and the third driving electrets E4 may have different sizes and thicknesses.

According to an example of FIG. 5, the aperture may be fixed in a first fixed position, a second fixed position, and a third fixed position respectively through the first driving electrets E2′, the second driving electrets E3′, and the third driving electrets E4. According to an example, the first fixed position may be determined by Coulomb force between the first driving electret E2′ and the fixed electret E1′. The second fixed position may be determined by Coulomb force between the second driving electret E3′ and the fixed electret E1′. The third fixed position may be determined by Coulomb force between the third driving electret E4 and the fixed electret E1′. According to an example, the number of fixed positions of the aperture may vary depending on the number of driving electrets included in the driving unit 1082′. When the number of driving electrets included in the driving unit 1082′ is n, the number of fixed positions of the aperture may be n. n may be a natural number of 2 or greater. That is, when the number of driving electrets included in the driving unit 1082′ increases, the number of fixed positions of the aperture may increase, and accordingly, an aperture driving module having various opening sizes may be provided.

Referring to FIG. 5, three driving electrets E2′, E3′, and E4 included in the driving unit 1082′ and one fixed electret E1′ included in the barrel 1081′ are disclosed. According to an example, the driving unit 1082′ may be fixed in a fixed position by Coulomb force between two driving electrets, among the three driving electrets E2′, E3′, and E4 included in the driving unit 1082′, and one fixed electret E1′ included in the barrel 1081′.

According to an example, the driving unit 1082′ may be fixed at a plurality of fixed positions equal to the number of driving electrets. In the case of the embodiment of FIG. 5, the driving unit 1082′ may be fixed in each of three fixed positions. According to an example, in the embodiment of FIG. 5, in each of the three fixed positions, the Coulomb force between at least one of the driving electrets E2′, E3′, and E4 and the fixed electret E1 may have a value (e.g., magnitude) greater than a weight of the driving unit 1082′. A time point at which this condition is determined may be a time point when the driving unit 1082′ is positioned in a fixed position. In addition, in each of the three fixed positions, the Coulomb force between at least one of the driving electrets E2′, E3′, and E4 and the fixed electret E1 may have a value less than a moving force for moving the driving unit 1082′. Alternatively, the driving unit 1082′ may be fixed in a plurality of fixed positions that are greater than the number of driving electrets.

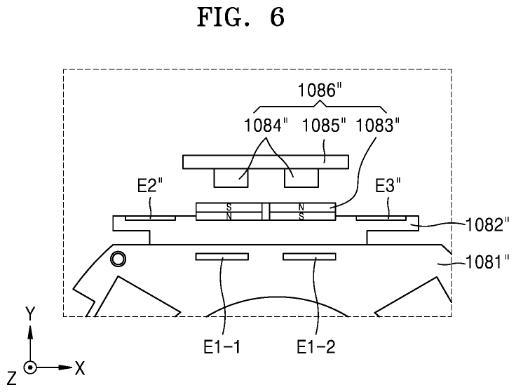

FIG. 6 is a partial plan view of the aperture driving module 108 according to an embodiment. In the example of FIG. 6, redundant descriptions of portions described above with reference to FIG. 4A may be omitted. According to an example of FIG. 6, a barrel 1081″ may include a plurality of fixed electrets. Referring to FIG. 6, the barrel 1081″ may include a first fixed electret E1-1 and a second fixed electret E1-2. Referring to FIG. 6, the barrel 1081″ and a driving unit 1082″ may each include a plurality of electrets.

Referring to FIG. 6, in a neutral position, the first fixed electret E1-1 may be located close to a first driving electret E2″. According to an example, the second fixed electret E1-2 may be located close to a second driving electret E3″. The two driving electrets E2″ and E3″ included in the driving unit 1082″ and two fixed electrets E1-1 and E1-2 included in the barrel 1081″ are disclosed. According to an example, the aperture may be fixed by Coulomb force between the first driving electret E2″ and the first fixed electret E1-1 in the first fixed position, and the aperture may be fixed by Coulomb force between the second driving electret E3″ and the second fixed electret E1-2 in the second fixed position. That is, when the fixed electrets are provided, the opening of the aperture may be fixed through the Coulomb force between the adjacent fixed electret and the driving electret in the fixed position of the driving unit 1082″.

Referring to the embodiments of FIGS. 4A to 6, the aperture driving module 108 according to the inventive concept includes the driving electrets included in the driving unit and at least one fixed electret included in the barrel. The driving electret and the fixed electret may each have charges. According to an example, the polarity of charges carried by the driving electret may be opposite to that of the charges carried by the fixed electret. The position of the aperture may be fixed by using the Coulomb force between the driving electret and the fixed electret charged with charges having opposite polarities, that is, the force between the electrets. In the case of the inventive concept, because the position of the aperture is fixed by attraction using the electrets, additional power (e.g., charges) may not be required or consumed when the position of the aperture is fixed.

According to another example, the polarity of the charge carried by the driving electret may be the same as the polarity of the charge carried by the fixed electret. The position of the aperture may also be fixed through repulsion between the driving electret and the fixed electret, when each charge has the same polarity. The aperture driving module 108 shown in FIGS. 4A to 6 is only an example, and the shape, arrangement position, size, etc. of the driving electrets included in the driving unit 1082 and the fixed electret included in the barrel 1081 may be variously changed within a range that satisfies the condition that the Coulomb force has a greater value than the weight of the driving unit.

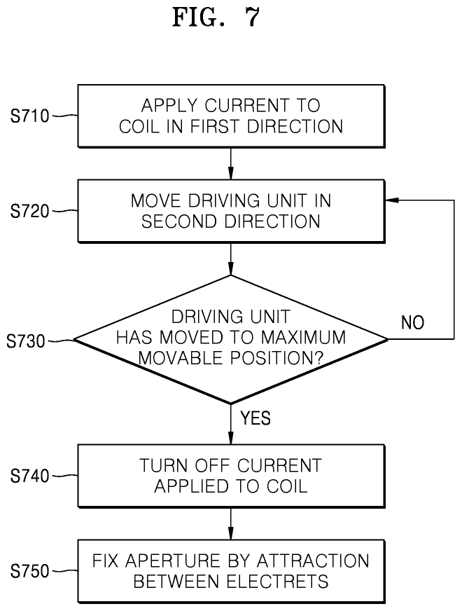

FIG. 7 is a flowchart illustrating a method for fixing an aperture according to an embodiment. Referring to FIG. 7, in operation S710, a current may be applied in a first direction to a VCM included in an aperture driving module. As the current is supplied to the coil, a Lorentz force acts on the coil in a certain direction. Because the coil is fixed to a substrate, a force may act on a magnet in a direction opposite to that of the Lorentz force according to the action-reaction law. In operation S720, through this, a driving unit to which the magnet is attached may move in a second direction. In operation S730, it may be determined whether the driving unit has moved to a maximum movable position after moving in the second direction. If the driving unit does not move to the maximum movable position, a current may be applied to the VCM until the driving unit moves to the maximum movable position.

In operation S740, when the driving unit has moved to the maximum movable position, the current applied to the VCM may be turned off. When the current applied to the VCM is turned off, the aperture may be fixed in operation S750 The aperture may be fixed through Coulomb force between an electret included in the driving unit and an electret included in the barrel. That is, the position of the aperture may be maintained without additional power consumption even after driving the aperture driving module through the VCM by force generated between the electret located in the driving unit and the electret located in the barrel. According to an example, the current applied to the VCM may be controlled by the lens controller (110 in FIG. 2) connected to the VCM. According to an example, the lens controller 110 may control the current to be turned off in a fixed position.

According to an example, the flowchart of FIG. 7 may be a flowchart in a particular embodiment in which two driving electrets are included in the driving unit and two fixed positions of the aperture are provided. According to an example, the flowchart of FIG. 7 may be a flowchart applied in a case in which there are two driving electrets and fixed positions of the aperture include a first fixed position in which the driving unit has moved to one end portion and a second fixed position in which the driving unit has moved to the other end portion.

According to an example, when there are three or more driving electrets, there may be three or more fixed positions, and in this case, operation S730 may be omitted. When there are three or more driving electrets, the aperture may be fixed in an additional fixed position by turning off the current without moving the driving unit to the maximum movable position. According to an embodiment, electrets may be used to form “n” distinct positions in which attraction between the electrets concentrates according to the arrangement type or number of electrets, so that the aperture may be controlled to be fixed into one of the “n” positions. In this case, n may be a natural number of 2 or greater.

A fixed position when minimizing the size of the opening may be a first fixed position. When the aperture is intended to be fixed in the first fixed position, the driving unit may be moved to the first fixed position by applying a current in the first direction, then the current may be turned off and the aperture may be fixed by the Coulomb force between the first driving electret and the fixed electret. When the operation of the camera module in the first fixed position is completed, the size of the opening may be changed to a neutral position or a second fixed position by applying a current in a direction opposite to the first direction. When the aperture is intended to be fixed in the second fixed position, the driving unit may be moved to the second fixed position by applying a current in a direction opposite to the first direction, and then, the current may be turned off and the aperture may be fixed by the Coulomb force between the second driving electret and the fixed electret.

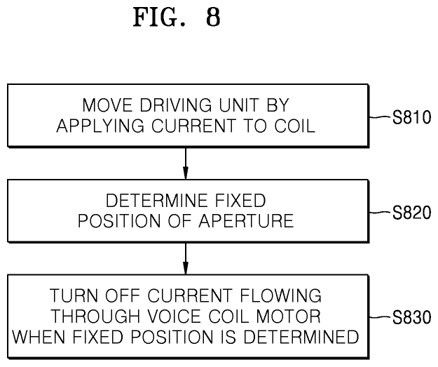

FIG. 8 is a flowchart illustrating a method for fixing an aperture according to an embodiment. According to an example of FIG. 8, in operation S810, the driving unit may be moved by applying a current to the coil. Thereafter, in operation S820, the lens controller may determine a fixed position of the aperture. In operation S830, when the fixed position is determined, a current flowing through the VCM may be turned off.

In operation S820, the fixed position of the aperture may vary depending on the number of driving electrets included in the driving unit. The fixed positions of the aperture may be the same as the number of driving electrets included in the driving unit. According to an example, in the determining of the fixed position of the aperture, it may be determined whether Coulomb force between the electret included in the driving unit and the electret of the barrel included in the aperture driving module is greater than the weight of the driving unit. According to an example, in the determining of the fixed position of the aperture, it may be determined whether the Coulomb force between the electret included in the driving unit and the electret of the barrel included in the aperture driving module is less than the force for driving the driving unit by the VCM. When it is determined that the above two conditions are satisfied, the fixed position of the aperture may be determined. According to an example, whether the above force condition is satisfied may be determined by the lens controller 110. According to an example, the meaning that the fixed position of the aperture is determined may refer to a case in which it is determined whether or not the above two conditions are satisfied when the driving unit is moved to the determined fixed position.

When the fixed position of the aperture is determined by satisfying the above two conditions in operation S820, the current may be turned off when the driving unit is located in the corresponding fixed position to prevent additional power consumption and the aperture may be fixed by the Coulomb force between the electrets in the corresponding fixed position in operation S830.

According to an embodiment, a narrowing depth of field (DoF) in a large sensor camera may be compensated for by using f/#tuning. In a large sensor camera, the DoF is narrowed due to an increase in an effective focal length (EFL) of an optical system, and this may be compensated for by tuning the f number using the aperture. The aperture driving module according to an embodiment may be applied to an upper portion of a barrel of a large sensor camera module, such as a pop-out, and may be used to prevent deterioration of the DoF.

According to the aperture driving module of an embodiment, additional power consumption for maintaining the size of the opening of the aperture is not required. According to the aperture driving module of an embodiment, material costs added to the camera module may be reduced by using general plastic as a material.

While the inventive concept has been particularly shown and described with reference to embodiments thereof, it will be understood that various changes in form and details may be made therein without departing from the spirit and scope of the following claims.

1. An aperture driving module, comprising:
a barrel configured to support an optical lens therein, said barrel comprising a first fixed electret;
an aperture blade configured to adjust an amount of light received by the optical lens, upon movement of the aperture blade; and
a driving unit having a first driving electret therein, said driving unit configured to move the aperture blade in response to application of a current to a voice coil motor (VCM), which has a magnet therein and is mounted adjacent a portion of the driving unit; and
wherein the first fixed electret extends apart from the magnet in a Y-axis direction, and the first driving electret extends apart from the magnet in an X-axis direction.

2. The aperture driving module of claim 1, wherein the magnet within the VCM is mounted at the driving unit; wherein the driving unit is physically connected to the aperture blade and attached to a side surface of the barrel; and wherein the first fixed electret and the first driving electret are charged opposite to each other.

3. The aperture driving module of claim 1, wherein the first fixed electret and the first driving electret include a material selected from a group consisting of teflon, polytetrafluoroethylene (PTFE), and Cyclized Transparent Optical Polymer (CYTOP).

4. The aperture driving module of claim 1, wherein the first fixed electret is located at a center point of the barrel.

5. The aperture driving module of claim 1, wherein the driving unit has a second driving electret therein, which is spaced apart from the first driving electret.

6. The aperture driving module of claim 5, wherein the second driving electret is charged with the same charge as the charge of the first driving electret.

7. A camera module, comprising:
an aperture driving module (ADM) driven by a voice coil motor (VCM), said ADM comprising:
a barrel configured to support a lens;
an aperture blade capable of adjusting an amount of light received by the lens; and
a driving unit attached to the barrel, said driving unit configured to drive the aperture blade such that an aperture blade opening has a first size when the aperture blade is in a first fixed position, and has a second size when the aperture blade is in a second fixed position; and
a lens controller configured to control a current flowing through the VCM, and further configured to turn off the current flowing through the VCM when the aperture blade is in the first and second fixed positions.

8. The camera module of claim 7, wherein the barrel includes a fixed electret, and the driving unit includes at least one driving electret.

9. The camera module of claim 8, wherein the driving unit includes a first driving electret and a second driving electret; and wherein the aperture blade is fixed in position by a Coulomb force between the first driving electret and the fixed electret in the first fixed position.

10. The camera module of claim 9, wherein, in the first fixed position, the Coulomb force between the first driving electret and the fixed electret has a magnitude greater than a weight of the driving unit.

11. The camera module of claim 8, wherein the driving unit includes a first driving electret and a second driving electret; and wherein the aperture blade is fixed in position by a Coulomb force between the second driving electret and the fixed electret in the second fixed position.

12. The camera module of claim 8, wherein the driving unit includes a first driving electret and a second driving electret, and the barrel includes a first fixed electret and a second fixed electret.

13. The camera module of claim 12, wherein in the first fixed position, the aperture blade is fixed by a Coulomb force between the first driving electret and the first fixed electret; and wherein in the second fixed position, the aperture blade is fixed by a Coulomb force between the second driving electret and the second fixed electret.

14. The camera module of claim 8, wherein the fixed electret and the driving electret are charged opposite to each other.

15. The camera module of claim 8, wherein the fixed electret and the driving electret include a material selected from a group consisting of Teflon, polytetrafluoroethylene (PTFE) and Cyclized Transparent Optical Polymer (CYTOP).

16. An aperture driving module, comprising:
a barrel including a fixed electret, and configured to support a lens; and
a driving unit mechanically coupled to the barrel, and including a plurality of driving electrets configured to move a plurality of aperture blades;
wherein the driving unit can be fixed into a plurality of fixed positions that are equal to or greater than a number of the driving electrets; and
wherein, in each of the plurality of fixed positions, Coulomb forces between at least one of the plurality of driving electrets and the fixed electret have magnitudes greater than a weight of the driving unit.

17. The aperture driving module of claim 16, wherein, in each of the fixed positions, the Coulomb force between at least one of the plurality of driving electrets and the fixed electrets has a magnitude that is less than a moving force for moving the driving unit.

18. The aperture driving module of claim 17, wherein the moving force for moving the driving unit is a moving force provided by a voice coil motor (VCM).

19. The aperture driving module of claim 16, wherein a charge density of the plurality of driving electrets and the fixed electret is in a range from about 0.1 mC/m² to about 10 mC/m².

20. The aperture driving module of claim 16, wherein the fixed electret and the plurality of driving electrets include a material selected from a group consisting of Teflon, polytetrafluoroethylene (PTFE) and Cyclized Transparent Optical Polymer (CYTOP).

21.-24. (canceled)
